(19) United States
(12) Patent Application Publication
(10) Pub. No.: US 2009/0219465 A1
(43) Pub. Date: Sep. 3, 2009

(54) Polarizing Display Device

(75) Inventors: Michael A. Vesely, Santa Cruz, CA (US); Carl Cobb, Woodside, CA (US)

Correspondence Address: FISH & RICHARDSON P.C., PO BOX 1022, MINNEAPOLIS, MN, 55440-1022, US

(73) Assignee: INFINITE Z, INC., Campbell, CA (US)

(21) Appl. No.: 12/040,726

(22) Filed: Feb. 29, 2008

(51) Int. Cl. G02B 27/26; G02F 1/1335

(52) U.S. Cl. 349/96; 445/22; 359/484

(57) ABSTRACT

A device for forming a stereo 3-dimensional image is described. Dual polarizing sheets are used to polarize light. A pixel control layer determines whether pixels are to be perceived by a viewer. Regions of the dual polarizing sheets are bleached in a manner that does not cause voids in or melting or warping of the sheets.

### TECHNICAL FIELD

This invention relates to polarized based image displays.

### BACKGROUND

Humans are able to perceive objects in 3-dimensional space, despite the fact that the human eye can only receive a 2-dimensional image. The image received by one eye differs slightly from the image received by the other, that is, the image perceived by one eye is slightly shifted from the image seen by the other eye. Stereoscopy is the effect of creating a 3-dimensional representation of an object from two 2-dimensional images of the object. Humans are able to perceive objects in 3-dimensional space because the human brain creates a stereoscopic effect by taking the 2-dimensional image received by each eye and using the differences between the two 2-dimensional images to determine the ratio of distance between nearby objects.

A typical stereoscopic display takes a pair of shifted super-imposed 2-dimensional images and creates a 3-dimensional illusion by revealing only one of the 2-dimensional images to each eye. This separation and isolation of the images may be implemented through methods using glasses (e.g., anaglyph methods, polarization methods, shutter methods) and methods not requiring the use of glasses (e.g., parallax stereogram, lenticular method, and mirror method—concave and convex lenses).

A polarizing stereoscopic display projects a pair of images through mutually exclusive polarizing filters—one image per filter. The viewer's glasses contain the same two polarizing filters—one in each lens—so that each eye can only see one of the images in the pair. The polarizing filters may be orthogonal linear, circular, or elliptical.

The pair of 2-dimensional images may be projected in either vertical perspective or horizontal perspective. Vertical perspective uses the traditional method of projection onto a vertical plane. The viewer's line of sight is perpendicular to the vertical viewing surface. Typically, in horizontal perspective, the image is rendered on a plane parallel to the ground.

In order to create a stereo 3-dimensional image in horizontal perspective, a 2-dimensional image must be precisely projected into one rendering for the viewer's left eye and projected into another rendering for the viewer's right eye. These projections are necessary because the distance between human eyes results in each eye receiving a naturally occurring image that is slightly different from that received by the other eye. Hence, in creating artificial stereo 3-dimensional imagery, the left eye and right eye images reflect the same two distinct versions of an image scene. The image versions for the left eye is then polarized so that it can be received through the polarized filter in the left lens of a pair of glasses worn by the viewer; a similar process applies for the right eye, but with a different polarization than the left eye. The viewer may perceive a stereo 3-dimensional image with depth cues when viewing the pair of distorted and appropriately polarized images through appropriately polarized glasses, because the viewer's brain fuses the two distorted 2-dimensional images received from each eye into a single undistorted stereo 3-dimensional image.

### SUMMARY

In one aspect, a method of forming a polarized pixel control layer assembly is described. The method includes receiving an assembly having a pixel control layer mated with a first uniform polarization layer, identifying a pixel cell within the pixel control layer and altering a first region of the first uniform polarizing layer that is associated with the pixel cell of the pixel control layer to deplete the region of light polarizing capabilities.

The method may include one or more of the following features. The pixel control layer can include a liquid crystal display device. The method of altering a first region can include forming a non-polarizing row. The method of identifying a pixel cell can include identifying a row of pixels of the pixel control layer and altering a first region can include altering a region corresponding to the row of pixels of the pixel control layer. Altering a first region can include creating a first polarizing sheet with a polarizing region and a non-polarizing region, the method can further include identifying a second region of a second uniform polarization layer of the assembly that is associated with the polarizing region of the first polarizing sheet and altering the second region of the second uniform polarizing layer to deplete the second region of light polarizing capabilities to form a second polarizing sheet with a polarizing region and a non-polarizing region. Altering the second region can include forming a laminate with alternating polarizing regions, wherein the polarizing region of the first polarizing sheet alternates with the polarizing region of the second polarizing sheet. The method can include identifying a third region of a third uniform polarization layer of the assembly, wherein the third uniform polarization layer is on an opposite side of the pixel control layer from the laminate and the third region is associated with the polarizing region of the second polarizing sheet and altering the third region of the second uniform polarizing layer to deplete the third region of light polarizing capabilities to form a third polarizing sheet with a polarizing region and a non-polarizing region. The method can include mating the second uniform polarization layer to an opposite side of the pixel control layer from the first uniform polarization layer. Altering a first region and altering a second region can form a checkerboard pattern of polarizing regions, wherein alternating polarizing regions polarize light at 90° with respect to one another. Altering a first region and altering a second region can form an interleaved pattern of polarizing regions, and alternating polarizing regions are cross-polarizing with respect to one another. Altering can include directing radiation at the first region at a fluence sufficient to cause aligned polarizing material to become unaligned. Altering can include directing radiation at the first region at a fluence below that which ablates the first uniform polarization layer. Identifying a pixel cell can include locating the pixel cell through the polarizing layer. The method can include altering a third region of the uniform polarizing layer.

In yet another aspect, a system comprising a light source, a pixel control layer and a dual polarizer between the light source and the pixel control layer is described. The system is configured such that the light emitted by the light source is directed as unpolarized light through the dual polarizer and the dual polarizer is a laminate with a contiguous surface.

The system may include one or more of the following features. The dual polarizer can be free of voids of any dimension greater than a wavelength of visible light. An upper surface and a lower surface of the dual polarizer at a first region that polarizes light of a first orientation can be substantially coplanar with an upper surface and a lower surface of the dual polarizer at a second region that polarizes light at a second orientation that is orthogonal to the first orientation. The dual polarizer can have a substantially constant index of refraction across the first region and the second region. The dual polarizer can have a substantially constant photoelastic coefficient across the first region and the second region, over a variety of temperatures. The dual polarizer can have a thickness of less than 500 microns. The dual polarizer can have an interleave polarizing pattern. The dual polarizer can have a checkerboard polarizing pattern. The dual polarizer can have a layer with first regions that polarize light of a first orientation and third regions that do not polarize light. The dual polarizer can include first regions, which are characterized by a linearly oriented material on a substrate and third regions, which are characterized by a randomly oriented material on the substrate. The pixel control layer can be a liquid crystal display device having cells, wherein one or more cells form a pixel. The dual polarizer can be a first dual polarizer and the system can further include a second dual polarizer on an opposite side of the pixel control layer from the first dual polarizer. The first dual polarizer and second dual polarizer can each have a first region that polarizes light of a first orientation and a second region that polarizes light at a second orientation that is orthogonal to the first orientation and the first region of the first dual polarizer and the second region of the second dual polarizer are along a single axis perpendicular to a main surface of the first dual polarizer.

The devices and techniques described herein may provide one or more of the following advantages. Because the polarizing sheets are treated in a way that prevents partial burning, melting or warping of the sheets, the index of refraction across the sheets remains uniform or constant. The polarizing sheets also have a transmission/reflection uniformity and a constant uniform expansion coefficient as a result of a common continuous material. Furthermore, the polarizing sheet is free of voids at the scale of the wavelength of visible light, which would cause increased light scattering. These each prevent uneven light scattering between treated regions, that is, non-polarizing regions, and non-treated regions or polarizing regions. A substantially uniformly flat surface and lack of discontinuities can prevent unwanted light scattering. The polarizing layers are formed on polymeric non-rigid sheets, which may be plastic sheets. Structural sheets can support the polarizing layers. The structural sheets can be formed of rigid or non-rigid plastic or other materials, such as cellulose. Plastic and cellulose sheets can enable forming a thin, compact, lightweight device that is portable. Further, use of plastic sheets allows the cost of the device to be kept relatively low. The techniques described herein also may allow for creating a dual polarization display in a manner that is self aligning with pixel creation elements of a pixel control device. The structure of the treated polarizing sheets in conjunction with a pixel control layer cab permit the use of an unpolarized light source.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic of a stereo 3-dimensional display device.

FIG. 2 is a diagram showing laser light passing through a polarizing sheet.

FIG. 3 is a side view of a polarizing assembly.

FIG. 4 is a plan view of a polarizing assembly.

FIG. 5 is a side view of a laminate.

FIGS. 6-9 are schematics of a stereo 3-dimensional display device.

FIG. 10 is a flow diagram for forming a treated sheet.

FIG. 11 is a schematic of a device for creating polarizing sheets.

FIGS. 12A-12D show charts for selecting laser attributes and system set up.

Like reference symbols in the various drawings indicate like elements.

### DETAILED DESCRIPTION

Display technology is continuously changing in an effort to bring viewers a better viewing experience. Some of these changes include increasing display image size, clarity and contrast. But a more fulfilling experience can be brought to a viewer by providing the viewer with a stereo 3-dimensional image. A stereo 3-dimensional image can make the viewer feel as though he or she is brought into the image and more fully experiences the image. While stereo 3-dimensional image technology is available in large and small screen formats, such as movie theaters, goggles and CRT television sets using shutter glasses, an alternative compact device capable of bringing such an image into a viewer's home, office or vehicle would increase the number of viewers that could enjoy a stereo 3-dimensional experience.

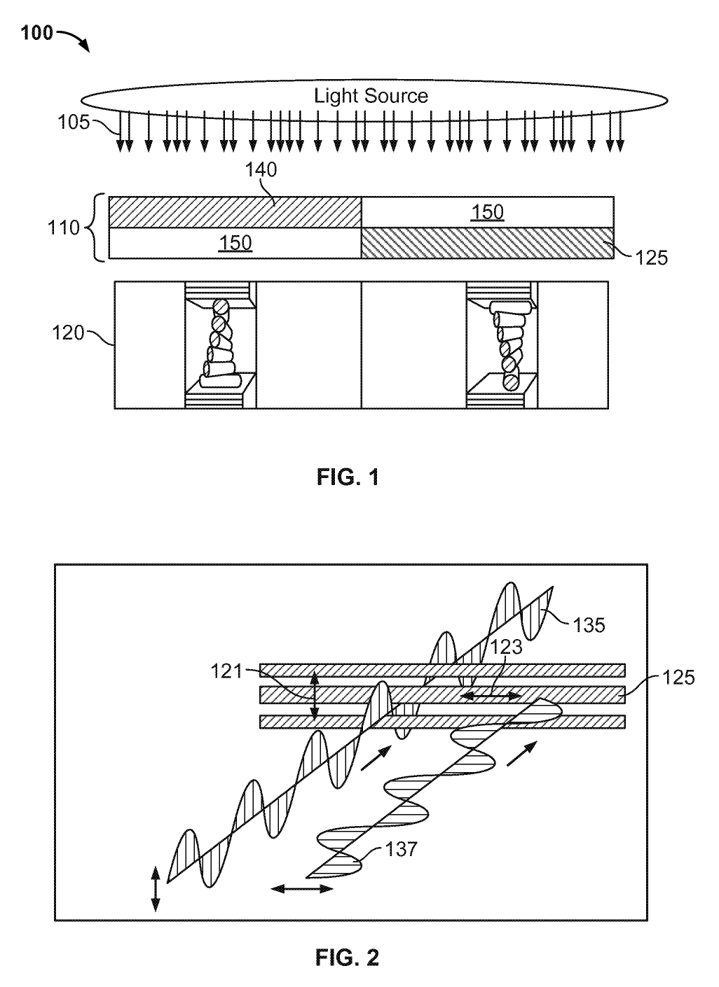

Referring to FIG. 1, an assembly 100 is capable of forming a stereo 3-dimensional image. The assembly 100 can form part of a physical display device that forms the image for a viewer to perceive. In addition to the following features, the physical display device can include components, such as a housing or control features, such as buttons, that control whether the device is on or off, and controls for color, contrast or brightness. Only a portion of the assembly 100, i.e., only two adjacent pixels of the assembly 100 are shown for the sake of simplicity. However, the assembly 100 can include multiple rows, each row including multiple pixels. The assembly 100 includes a light source 105, a polarizing sheet stack 110 and a pixel control layer 120. The light source 105 can be any backlight source that provides sufficient power to enable forming an image of desired viewing quality, such as an LED, OLED, fluorescent tubes or other light source. In some embodiments, the light source creates a non-polarized, scattered, and uniform, such as a planar, source light. A dispersion sheet can be used to create a planar source of light. In some embodiments, the light source 105 is an unpolarized substantially white light source. The light source 105 is arranged so that light is directed towards the polarizing sheet stack 110.

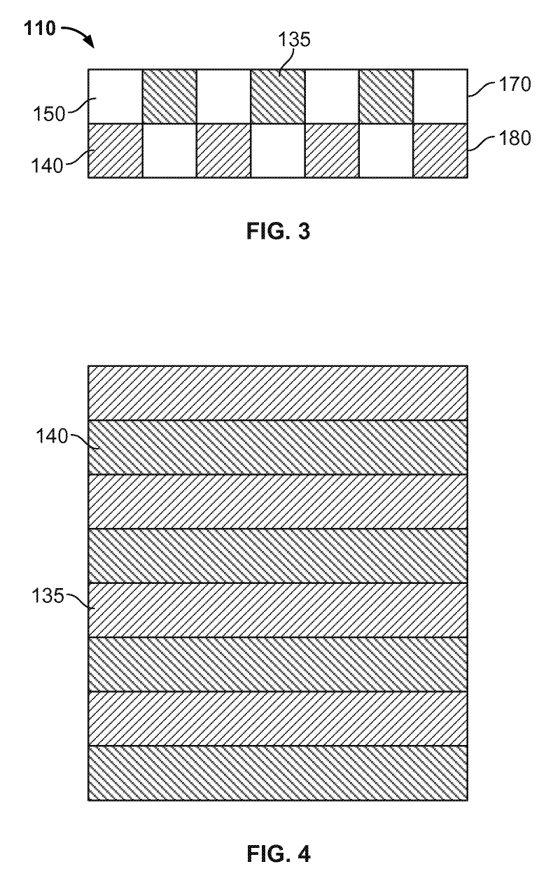

Referring to FIG. 2, the polarizing sheet assembly 100 includes regions 125 that allow light with a field component that is oriented parallel 135 to the sheet's polarization axis 121 and perpendicularly oriented to the sheet's direction of aligned material 123 to pass through the regions 125, while blocking out light 137 at orientations perpendicular to the sheet's polarization axis 121 and parallel to the sheet's direction of aligned material 123. The polarizing sheet stack can include one, two or more layers that are capable of polarizing light. The stack can also include other layers, such as non-filtering layers, such as adhesive, support or other layers that do not polarize light. In some embodiments, the polarizing sheet stack 110 has alternating regions, where every other region is capable of alternately polarizing light with respect to the other regions. Referring back to FIG. 1, the pixel control layer 120 is capable of turning each pixel on or off. In some embodiments, the pixel control layer 120 is a liquid crystal display (LCD) device. Only one example of a pixel control layer 120 is shown for sake of simplicity. However the pixel control layer 120 can include one of many types of pixel control layers.

In order to create a stereo 3-dimensional image, while regions 125 of the polarizing sheet stack 110 block light of one orientation, other regions 140 block light of a different orientation. Light at orientations that is able to pass through the regions 125 is substantially blocked by the regions 140 and light at orientations that is able to pass through regions 140 is substantially blocked by regions 125. In some embodiments, the light that passes through regions 125 is orthogonal to the light that passes through regions 140. Further, in some embodiments, the regions 125 alternate with regions 140, in a checkerboard, interleave, cluster, or abstract pattern. This forms alternating pixels, thus forming alternating image information, which facilitate forming the stereo 3-dimensional image. The formation of the image is further described below.

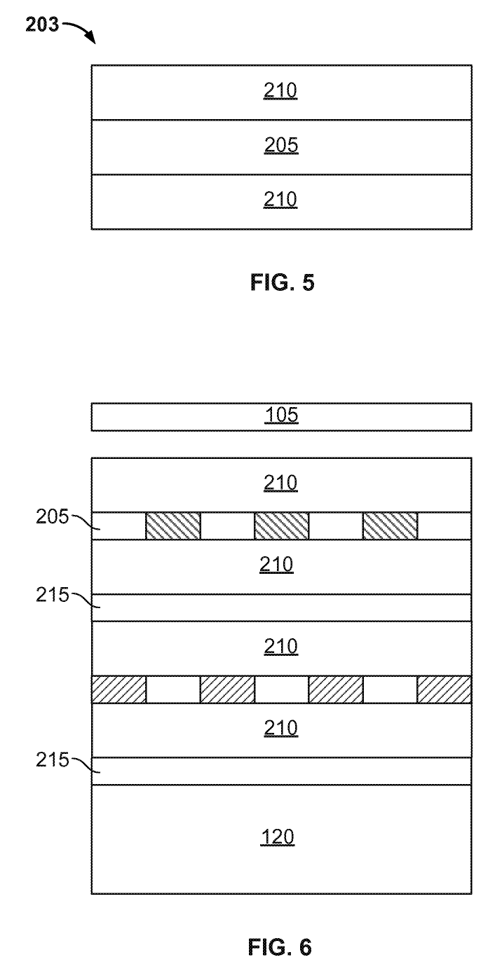

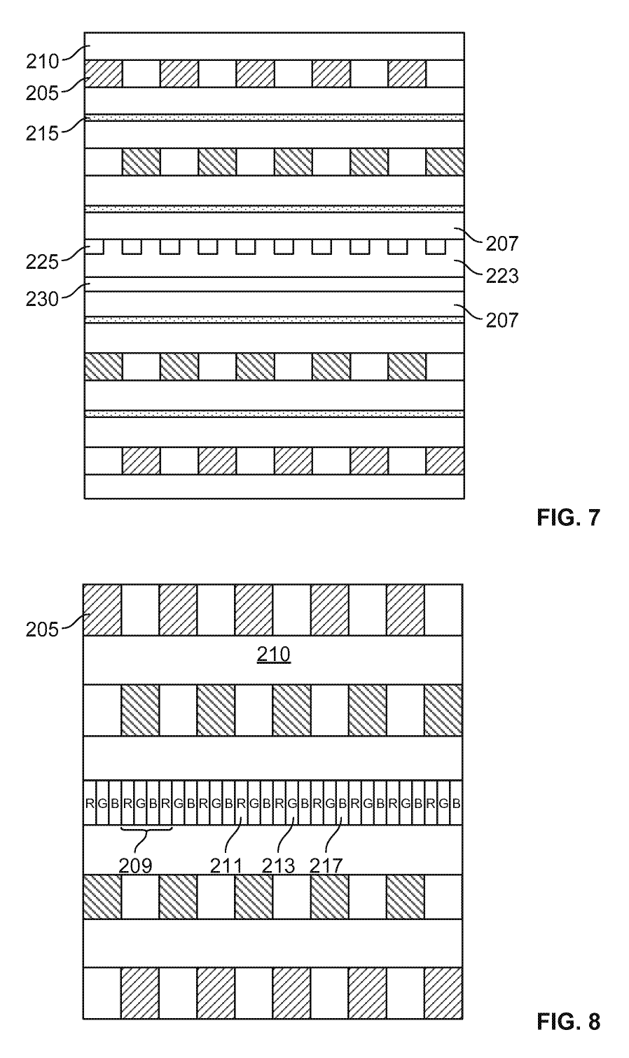

Referring to FIGS. 3-4, in some embodiments, the polarizing sheet stack 110 includes two sheets 170, 180. FIG. 3 is a cross-sectional view of part of a sheet stack with an interleave pattern and FIG. 4 is a plan view of a part of the same sheet stack. The first sheet 170 has regions 125 that block light of a first polarization orientation. Additionally, the first sheet 170 has regions 150 that allow light of all orientations to pass through, that is, let substantially all incoming light to pass through. The second sheet 180 has regions 140 that block light of a second, different polarization orientation, as well as regions 150 that allow light of substantially all orientations to pass through. The two layers where one layer has regions with the ability to polarize light in one orientation and the other layer has regions with the ability to polarize light at orientations perpendicular to the first layer is referred to herein as a dual polarizer. The dual polarizer can further include other layers, such as structural layers described further herein.

Each sheet includes a substrate and may include one or more materials or layers of materials applied on the substrate. The substrate may affect the light passing through in some small way, such as by scattering, absorbing, or providing some minor filtering. However, the substrate is selected to not polarize light on its own. That is, the substrate is selected to minimize any effects on the light that passes through the substrate. The regions 150 that allow light of all orientations to pass through that are in the first sheet 170 overlap or are aligned with the regions 140 that only allow light of a single orientation in the second sheet 180 to pass through. Similarly, the regions 150 in the second sheet 180 that allow all light to pass through are aligned with or overlap the regions 125 of the first sheet 170 that only allow light to pass through that is of the first orientation. The regions can have a size that correlates to a pixel or set of pixels within the pixel control layer that is in the range of about 179 microns×255 microns for a pixel or less, such as 179×85 microns or less for a single LCD cell with a pitch between rows of 255 microns. The size can be a row width or a dimensions of a rectangle. In some embodiments, the regions have a lateral area of less than 1 micron squared. In some embodiments, the regions have a lateral side measurement of less than 600 microns.

Referring to FIG. 4, a plan view of the polarizing sheet stack 110, because of the alignment of the regions 125, 140, the resulting polarizing sheet stack 110 has alternating regions, where every other region allows the same orientation of light to pass through. Each region corresponds to one or more pixels in the final stereo 3-dimensional image. Further, there are no or are insignificant areas where light of all orientations is able to pass through the stack 110. While in some embodiments, the two sheets 170, 180 and their associated regions are arranged so that there are no regions in the overall assembly that block all orientations of light, some small amount of overlap can be acceptable to clearly define the pixels and avoid any image distortion or noise. In some embodiments, the polarizing layer has a boundary between treated regions, i.e., polarizing regions, and non-treated regions, i.e., non-polarizing regions of less than 2 microns. The boundary portion is partially depolarized and therefore is a region of partial polarization.

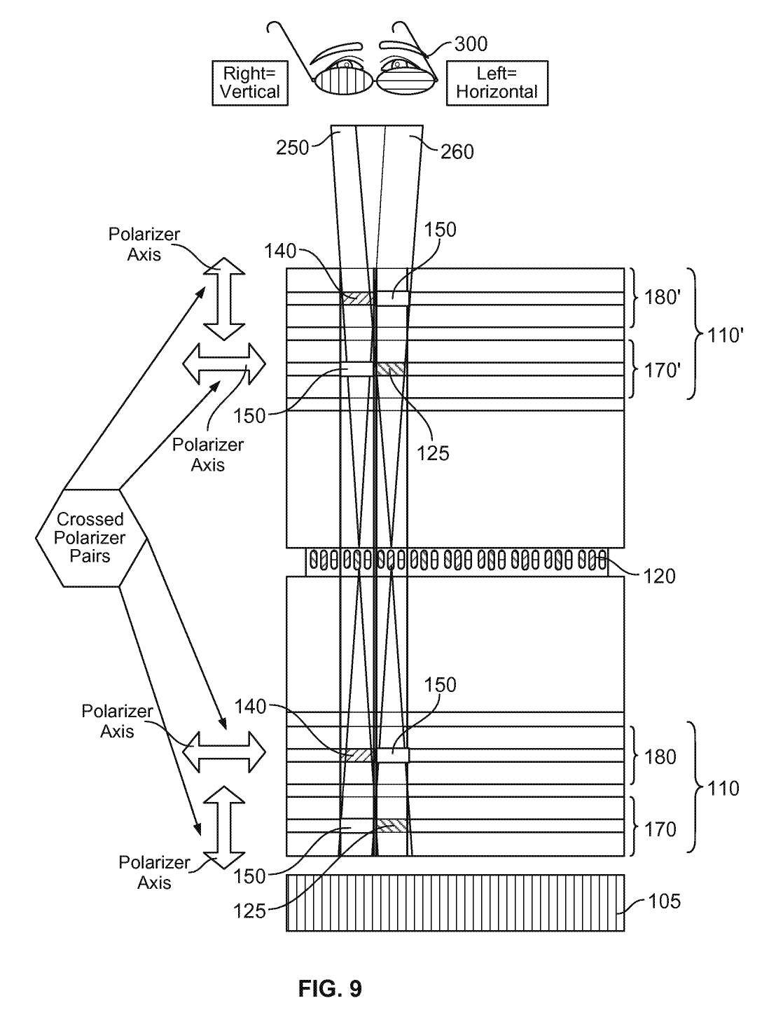

Referring to FIG. 5, in some embodiments, a polarizing sheet stack can include a laminate 203 of multiple layers. Polarizing layer 205 is sandwiched between structural layers 210 that provide support to the polarizing layer 205. The structural layers 210 can be formed of a flexible and transparent material, such as a polymer film, protective film or cellulose based film, for example, triacetate cellulose (TAC) or olefin polymers or copolymers. TAC can have a small birefringence of 5 to 10 nm in the plane of the film and a higher negative out-of-plane birefringence of 50 to 70 nm. The structural layers 210 can each have a thickness of between about 30 and 100 μm, such as a thickness of at least 20 microns, such as 40 microns or 80 microns. The structural layers 210 provide protection for the polarizing layer 105, such as from scratching, smudging or attack by moisture.

The polarizing layer 205 includes a substrate, such as a transparent substrate. The transparent substrate of the polarizing layer 205 can also be a plastic material, such as polyvinyl alcohol (PVA). Each of the layers has substantially parallel bottom and top surfaces. In addition, the laminate has substantially parallel bottom and top surfaces. The layers, as well as the laminate, have a continuous surface. The laminate has continuous surfaces, that is, the laminate is free of process induced voids. In some embodiments, any interior layers of the laminate are free of process induced voids, such as voids at the scale of the wavelength of light. In some embodiments, the structural layers 210 and the substrate of the polarizing layer 205 each have a layer transparency of at least 85%, such as at least 90% or at least 95%.

The substrate has a polarizing material in the regions that block an orientation of light. In some embodiments, the polarizing material is aligned iodide complexes. In other embodiments, the polarizing material is aligned silver. The polarizing layer 205 can be formed by applying silver or iodine to the substrate, stretching the substrate and attaching the stretched substrate to the structural layers 210 to keep the stretched substrate in its stretched form. The stretching causes the applied silver or iodine to elongate in the stretching direction. In some embodiments, the polarizing layer 205 has a thickness of less than 500 μm, such as a thickness of about 30 μm. In some embodiments, the overall laminate has a thickness of less than 200 microns. Optionally, the laminate 203 includes a pressure sensitive adhesive. Additional coatings or layers, such as a hard coating, antiglare, antismudge or other coatings can also be included on the laminate. Suitable iodine based laminates are available from Nitto Denko, Fremont, Calif., such as SEG1423DU or TEG1463DU.

When a layer of aligned iodine forms the polarizing layer, light oriented parallel to the direction of the aligned doped material direction is absorbed. That is, electromagnetic vibrations that are in a direction parallel to the alignment of the molecules are absorbed. Light oriented perpendicular to the direction of the aligned doped material passes through the polarizing layer.

As described further herein, the polarizing layer 205 starts out as a substantially uniform polarizing layer across a substantial region of the sheet. The regions (e.g., regions 150 in FIG. 3) that are to allow all or most orientations of light to pass through are then treated to form regions that are not capable of polarizing light. Two polarizing layers 205 are placed adjacent to one another with their polarizing directions different from one another, such as orthogonal to one another. Adjacent sheets can be stacked on top of one another such that a main surface of one layer is adjacent to a main surface of the other layer. The two treated polarizing layers 205 together form a polarizing sheet stack 110.

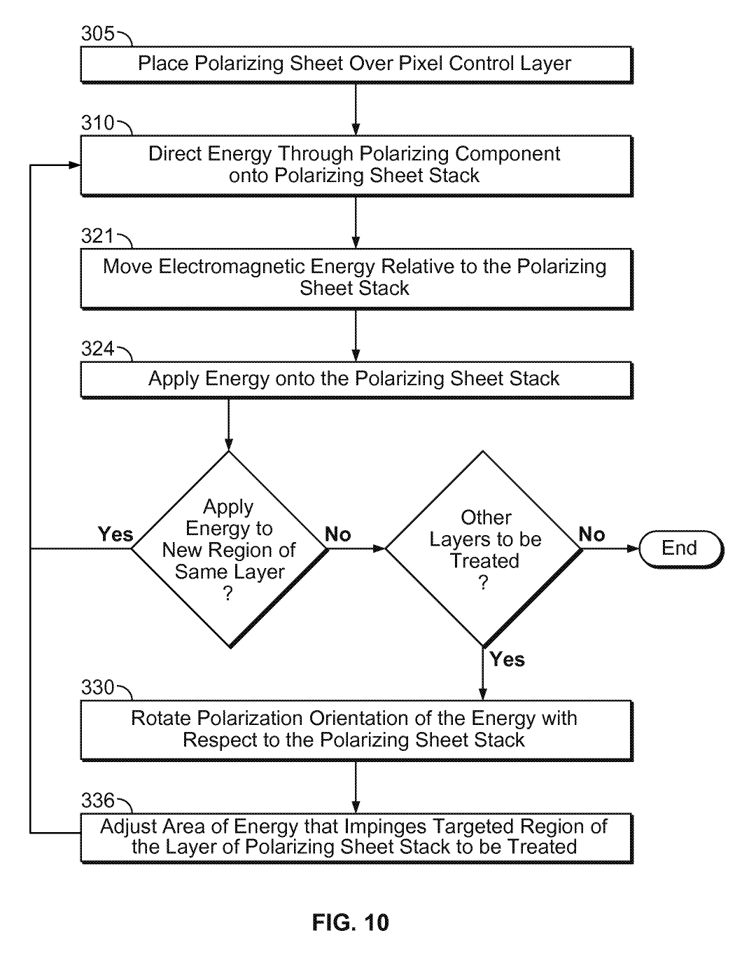

Referring to FIG. 6, a treated laminate is shown used with the assembly 100 of FIG. 1. Two treated laminated are located between the light source 105 and the pixel control layer 120. A layer of pressure sensitive adhesive 215 is between the two laminates and is between the laminates and a pixel control layer 120. Referring to FIGS. 7-8, in some embodiments a second stack of laminates is on an opposite side of the pixel control layer 120. This forms a sandwich of an upstream polarizing sheet stack 110, a pixel control layer 120 and a downstream polarizing sheet stack 110.

The pixel control layer 120 can be an LCD panel formed of a pair of sheets 207 between which liquid crystal materials and embedded circuitry is placed. Frequently, the sheets are glass, because many LCD formation processes require high temperatures that are above the melting point of many plastics. The circuitry can include electrodes 225, 230, which are controlled by a controller (not shown). When a pair of electrodes is biased, the liquid crystal material 223 of a twisted nematic cell twists or untwists to either rotate or not rotate light that passes through the pixel control layer 120. If the pixel control layer 120 includes filter material, a display capable of forming a multi-colored image can be formed, as shown in FIG. 8. A multicolored capable display can have one of each color filter overlapping with a single pixel or subpixel. A pixel 209 is often a red 211, green 213 and blue cell 217. Controlling the color of the pixel can be achieved by just controlling the on or off state of the appropriately colored subpixel. The color filters are then controlled by a controller and software to provide the proper amount of color to each pixel to cause the viewer to perceive a full color display. The LCD panel can be a 2-dimensional array, with pixels extending in both an x and a y direction.

Referring to FIG. 9, the operation of the device in FIG. 8 is described. Again, only two pixels are shown and described for the sake of simplicity. Light is provided by light source 105. Light from a first area of the light source 105 will eventually form a first pixel element 250 and light from a second area of the light source 105 will eventually form a second pixel element 260. The light is directed through the upstream polarizing sheet stack 110. A first sheet 170 of the polarizing sheet stack 110 allows the light of all orientations from the light source 105 to pass through regions 150 at the first pixel element 250 and blocks light passing through region 125 that is parallel to the axis of polarization that is associated with the image pixel element 260. Here, the first sheet 170 is shown as having a vertical polarizing axis. Thus, vertically oriented light passing through region 125 is blocked. The polarized light then passes through the second sheet 180. Because of the alternating regions, region 140 of the second sheet 180 blocks the light parallel to the polarization axis and region 150 of the second sheet 180 (which is shown as horizontal) and allows all of the vertically polarized light at pixel element 260 to pass through.

Light then travels through the pixel control layer 120. Depending on whether a pixel is to be turned “on” or “off”, a controller biases the corresponding electrodes appropriately. The controller also controls the electrodes to turn “on” or “off” the cells associated with the colored filters to send the light through the appropriate color filter. In FIG. 9, both pixels are turned on. If the pixel control layer 120 is a twisted nematic LCD device, the light is twisted 90° as it passes through the layer 120. Thus, upon exiting the layer, the light is at a different angular polarization orientation than when it entered the device. The twisted nematic LCD device can show either normally black or normally white cells. As an alternative to twisted nematic LCD cells, InPlane Switching (IPS), vertical alignment (VA), multiple vertical alignment, patterned vertical alignment, super vertical alignment (SVA), optical compensated bend (OCB), electrically controlled birefringence (ECB) LCD cells or any other LCD cell type could be used. The orientation of the polarizing sheet stack is selected based on the type of pixel control layer, how the pixel control layer affects the light and how the controller controls the pixel control layer.

On the downstream side of the pixel control layer 120 is a downstream polarizing sheet stack 110′. The light that has passed through the pixel control layer 120 passes through a first sheet 170′ of the polarizing sheet stack. Because the light is rotated 90° when a pixel is turned on, the first sheet 170′ of the downstream polarizing sheet stack 110′ has the same polarizer axis as the second sheet 180 of the upstream polarizing sheet stack 110. Here, the first sheet 170′ of the downstream polarizing sheet stack 110′ has a horizontal polarizer axis and the second sheet 180′ has a vertical polarizer axis.

In some embodiments, the on state and the off state of the pixels are controlled so that the viewer sees light when the pixels of the pixel control layer are in the off state. Pixels in the off state in a twisted nematic LCD do not twist the polarized light. Thus, the assembly is arranged with the first sheet 170′ of the downstream polarizing sheet stack 110′ having the same polarizer axis as the first sheet 170 of the upstream polarizing sheet stack 110. Similar to the first polarizing sheet stack 110, the horizontally polarized light at the first pixel element 250 passes through region 150 of the first sheet 170′ and the vertically polarized light at the second pixel element 260 is passes through the region 125. The horizontally polarized light at the first pixel element 250 then passes through the second sheet 180′ at the region 140′ and at pixel element 260 vertically polarized light passes through region 150. With many types of LCDs that can be used as the pixel control layer, when the pixel control layer turns pixels off, light is still able to pass through the layer. The difference between the on pixels and off pixels is the orientation of the light. Thus, the second polarizing sheet stack 110′ blocks light passing through the pixel control layer that is not to be perceived by the viewer. The orientation of the downstream polarizing sheet stack when the assembly is formed is determined by how the pixel control layer will be controlled when used to form a stereo 3-dimensional image.

A viewer wears polarizing glasses 300 in order to view the stereo 3-dimensional image. One lens is polarizing at 90° with respect to the other lens. Therefore, in some embodiments, one eye receives the vertically polarized light and the other eye receives the horizontally polarized light. However, the light can be at other orientations as well. Because each eye is receiving a different image simultaneously, the viewer perceives a stereo 3-dimensional image produced by the two images.

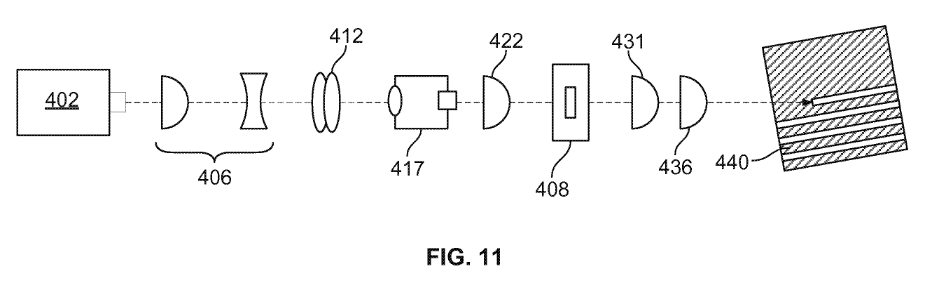

Referring to FIG. 10, in some embodiments, the polarizing sheet stack is formed using the following technique. The technique describes bleaching one or more regions of a polarizing sheet. When bleaching, the polarizing sheet is not materially affected in that the sheet is neither burned, melted, discolored nor warped due to the input of energy, such that the sheet returns substantially to its previous state, but the bleaching causes the polarizing material to no longer be able to polarize light. A polarizing sheet of a first polarization orientation is placed on to a pixel control layer (step 305). The polarizing sheet and pixel control array can be mated together, such as with an adhesive. Optionally, the starting region of the polarizing sheet stack to be treated is optically determined, such as by naked eye, through a camera or through a magnifying lens or through an image recognition system.

The energy to be directed onto the polarizing sheet is selected to match the polarization of the polarizing sheet. Matching the polarization can include matching the polarization orientation of the energy emitted by the energy source to that polarization orientation of the polarizing sheet. A waveplate, such as a 1/2 wave plate is optionally placed over and aligned with a layer of a polarizing sheet stack, where the polarizing sheet stack has at least one layer of polarizing material. The waveplate is not needed if the polarizing sheet and the energy source can be oriented in such a way to cause bleaching of the polarizer. In some embodiments, there are two layers of polarizing material adjacent to, that is, stacked on top of, one another. If there are two layers, the layers of polarizing material are arranged so that one layer has a polarization orientation that is orthogonal to the other layer. The 1/2 waveplate is rotated or positioned so the linearly polarized energy is aligned with the absorption axis of the target linear polarizing layer. For example, if the top layer, or layer closest to the waveplate, is to be treated first, the waveplate is arranged to transmit light of the same orientation as the closest layer. Alternatively, if the layer furthest from the energy source is to be treated, the polarization orientation of the energy is selected so that it passes through the closest polarizing sheet and affects the further polarizing sheet. Thus, the uppermost polarizing sheet can be irradiated through to bleach the lowermost layer.

Energy is then directed onto the polarizing sheet stack (step 310). Optionally, the energy is directed through a waveplate. In some embodiments, the energy is laser light with a wavelength between 450 and 650 nm. In some embodiments, the energy is directed through a mask that ensures that a precisely defined location on the polarizing sheet stack receives the energy. For example, in some embodiments, only a square region of the sheet stack receives the energy. The region can alternatively be another shape, such as circular, oval, rectangular or hexagonal. In some embodiments, beam focusers and/or spreaders are used to control the application of energy onto or into the polarizing sheet stack. The energy that is directed onto the polarizing sheet stack is selected to deliver an accurate amount or characteristics of the energy onto the polarizing film. Some characteristics of the energy that can be selected include, but may not be limited to, wavelength, fluence, power, irradiation and focus location. In some embodiments, the layers that are not to be affected by the energy, such as any supporting layers, do not materially absorb the energy.

In some embodiments, the energy is selected so that the substrate of the polarizing layer is not materially affected, that is, so that the substrate is neither burned, melted, discolored nor warped due to the input of energy. After application of the energy, the polarizing layer returns substantially to its previous state, but without the polarizing material able to polarize light. This can be controlled by controlling the time of energy input, the power, the area to which the energy applied or a combination thereof. If the layer is irradiated for too long or with too much energy, the energy may cause the temperature of the layer to increase and cause distortion, such as bending, melting or warping, of the layer. To maintain a flat or substantially planar layer, the energy is selected to stay below a melting point of the substrate. This allows the index of refraction to remain uniform across both treated and non-treated regions of the layer. For example, the index of refraction across the sheet may be a constant for a particular wavelength ±5%. Because the substrate material is not burned, voids are not formed in the substrate. This obviates the need to fill the voids with another material, which could have a different index of refraction, thermal expansion coefficient or combination thereof. If a material with a different index of refraction or thermal expansion coefficient is in voids in a polarizing sheet, under some operating conditions, such as at elevated temperature, the difference in materials can cause light scattering. This can result in a mechanical stress between two different materials that may not be apparent at some temperatures, but is apparent at other temperatures. With the polarizing sheet stacks described herein, the materials in each layer, particularly the materials of the substrate, are substantially constant across the layer. Thus, there is a constant photoelastic coefficient over polarizing and non-polarizing regions within a single layer and across the sheet stack. The photoelastic coefficient is constant over a variety of stresses and temperatures.

If the layer has aligned iodine as the polarizer, the energy input is sufficient to excite the substrate and/or the iodine enough to release the bond between the iodine and the substrate on which the iodine is located. When the bond breaks, the iodine relaxes from its aligned state. A region with non-aligned iodine is not able to polarize light that is transmitted through the region. In effect, the regions are bleached, without materially affecting the substrate characteristics in the regions. Without being held to any particular theory, it is believed that polyiodide compounds, such as KI₃ and KI₅ are dichoric absorbers. The ionic I₃⁻ and I₅⁻ combine with the PVA to form covalent attachments. When the KI₃ and KI₅, which are metastable, are heated, they decompose into KI and I₂. A temperature of as little as 85° C. for 1000 hours can break down the iodide compounds. At 150° C., the compounds can break down very rapidly. Selecting the energy input characteristics for bleaching the regions is described further herein.

The electromagnetic energy and polarizing sheet stack are moved with respect to one another so that the energy can be directed at the next target region on the polarizing layer (step 321). The next target region can be in alignment with a group of pixels or rows or group of pixels on the pixel control layer. The energy source again applies, or continues to apply, energy into the polarizing layer of the polarizing sheet stack (step 324). These steps are repeated until the number of desired transmissive regions are formed on the polarizing sheet stack.

Once one layer of the stack has its targeted region or regions completely treated, a next polarizing sheet (attached to the assembly) and a polarization orientation of the energy are rotated with respect to one another such that the energy can treat the next polarizing sheet (step 330). If there is only one polarizing sheet on the pixel control layer, that is, a first polarizing sheet, a second polarizing sheet can be added to the assembly. The second polarizing sheet is able to polarize light at 90° with respect to the first polarizing sheet. If the waveplate is used to control the polarization orientation of the energy, it can be rotated into the correct position. For example, if the waveplate is a 1/2 wave waveplate, the waveplate is rotated 90°. Alternatively, the polarizing sheet stack is rotated 90°. The regions of the second polarizing sheet to be treated can be determined by finding regions on the pixel control layer that are to be in alignment with the treated regions of the second polarizing sheet or by finding regions in the first polarizing sheet that are polarizing regions that are to be in alignment with the treated regions of the second polarizing sheet. The second polarizing sheet regions to be treated are identified by recognizing the cell or cells of the pixel control layer optically through the second and first polarizing sheet.

If needed, the polarizing sheet stack is moved or the assembly for treating the polarizing sheet stack is adjusted to adjust the area of the energy that impinges the targeted regions of the layer of the polarizing sheet stack to be treated (step 336). If the layer to be treated is closer to an adjusting lens (described further below) or energy source, then the area of the energy that impinges on the layer will be less than the area that impinges on a layer that is further from the adjusting lens or energy source. The other layer is then treated using the same steps as applied to the first layer that was treated. To create the alternating pattern of regions, the regions that are treated on the first layer are the regions that are not treated in the second layer.

In some embodiments, the polarizing sheet stack is treated while attached to the pixel control layer. If the polarizing sheet stack is attached to the pixel control layer prior to being treated, the regions that are depolarized can be easily aligned with the appropriate regions of the pixel control layer. Further, if the pixel control layer is a rigid layer, such as a glass based LCD panel, and the polarizing sheet stack or laminate is flexible the pixel control layer provides structure and support to the flexible material. This also obviates a step of aligning a treated polarizing sheet stack or laminate with pixel regions of the pixel control layer. The regions to be depolarized or bleached can be determined by using fiducial marks on the pixel control layer or observing the actual cells of the pixel control layer through the polarizer. The regions or cells of the pixel control layer that are associated with a particular polarization can be determined by viewing the cells through a polarizing layer. The depolarizing energy beam can be aligned to the array of cells by viewing the cells (or the fiducial) through the polarizer. Thus, the desired regions can be irradiated over the desired cells of the pixel control layer.

If the polarizing sheet stack is treated before being attached to the pixel control layer, the treated stack is aligned with the pixel control layer and bonded to the pixel control layer. This can be done by visually lining up the treated regions and pixels regions of the pixel control region or by forming registration marks on the layer and stack before bonding.

If a second polarizing sheet stack is desired on the opposite side of the pixel control layer, a second sheet stack is treated on the pixel control layer. If necessary, the second sheet stack is bonded to the pixel control layer if it is not already part of the assembly when being treated. Alternatively, if the second sheet stack is already a part of the assembly, the assembly is simply flipped over and treated. If the assembly is treated, that is if the pixel control layer has the polarizing sheet stacks attached during treatment, the pixel control layer can be turned on or off to prevent any stray energy from passing through the pixel control layer and adversely affecting the stack that is not currently being treated. In some embodiments, a first triple laminate of two support layers and a polarizing layer is attached to the pixel control layer, and then the first triple laminate is treated. After the first triple laminate is treated, a second triple laminate is added to the assembly on top of the first triple laminate and is treated. The second triple laminate is capable of polarizing light oriented at 90 degrees relative to the first triple laminate.

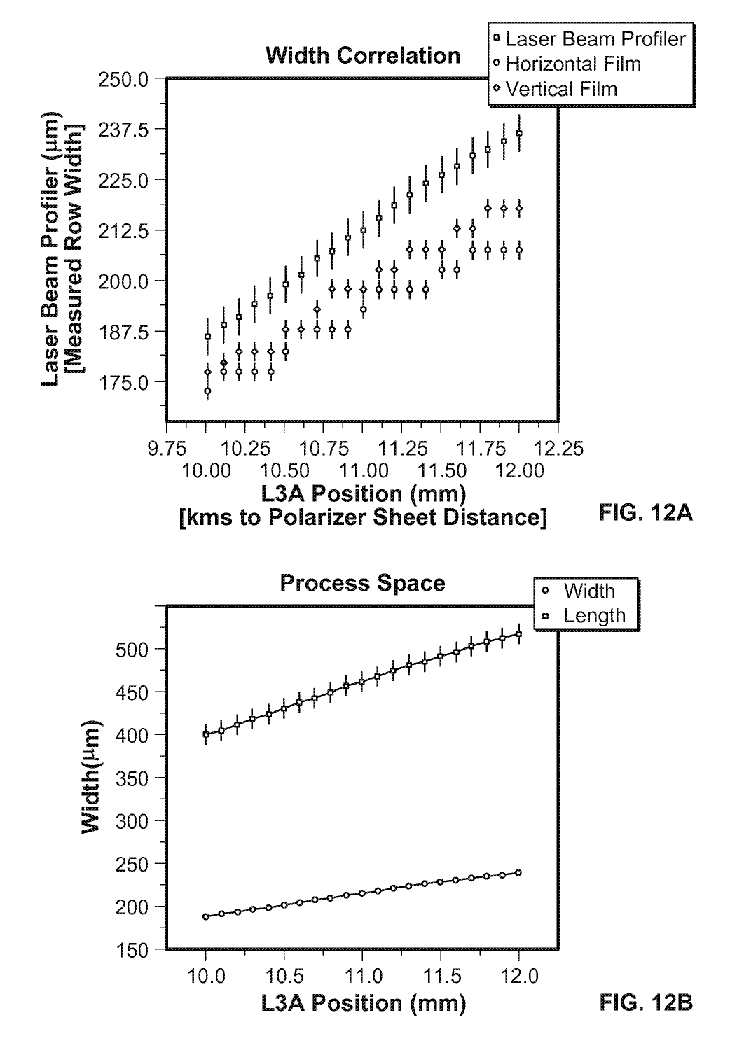

Referring to FIG. 11, an exemplary apparatus for treating a polarizing sheet or stack is shown. An energy source 402 can include a device that emits light, such as coherent light, for example, a laser, or an arc lamp or a flash lamp. The beam of energy emitted by the energy source 402 is focused or spread by one or more beam focusing or beam spreading lenses 406. The broadened and/or focused beam can then be sent through a waveplate 412, such as a 1/2 wave rotatable waveplate to effect light of the desired orientation based on the polarizing layer to be treated. If the beam is to be shaped, such as from a circular beam profile to a square beam profile, the oriented beam is directed through a remapper 417. From the remapper, additional focusing can be performed by a beam focusing lens 422. Because the edges of the beam may be more diffuse than a center and ideally an entirety of a region is treated uniformly, a mechanical slit 428 or mask can clip, hence sharpen the edge of the beam. The beam can be further focused by a subsequent focusing lens 431 to further narrow down the beam. The beam width can then be adjusted by adjusting the distance with a final convex adjustment lens 436. The beam then impinges on a polarizing layer, which is positioned so that the beam is directed at a desired location for bleaching. A positioner (not shown) can move the polarizing sheet stack 440 relative to the energy beam, such as to form the treated rows. One or more of the components can be optional in the apparatus. In addition, other components, such as attenuators, may be added to the apparatus.

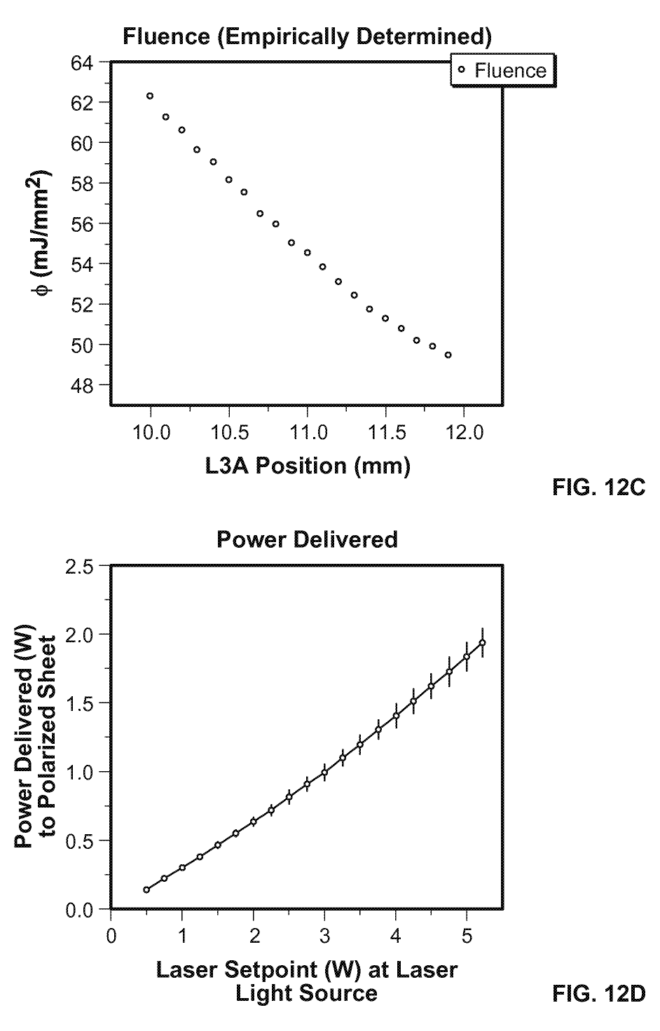

Referring to FIGS. 12A-12D, the proper energy for impinging onto the polarizing sheet stack can be selected using the following considerations. Charts are shown for a 532 nm green laser light. However, the charts could be adapted for other light sources. First, a Width Correlation chart (FIG. 12A) is used to determine the distance of the adjustment lens to the polarizing sheet, given the intended polarizing region to treat. If there are two layers to be treated and one layer is vertically polarized and the other is horizontally polarized, it is first determined which sheet is to be treated, either the horizontal film or the vertical film. A desired width of the treated regions, or row width, is selected along the “laser beam profiler (μm) [measured width]” axis or ordinate axis. Along the abscissa, the horizontal or vertical polarizer intersection point is found. At the intersection point along the abscissa (shown as L3A Position) is the adjustable lens to polarizer sheet distance for focusing the light at the desired layer for treatment. In addition, the chart provides information on the actual spread of the beam at the laser beam profiler intersections, which result in the desired bleached region width. The laser beam profiler intersection is found according to the abscissa point selected. A width slightly greater than the desired width of the treated region can be selected at this stage. In practice, the width of the energy beam applied is slightly greater than the area of iodine that is actually dissociated on the polarizing sheet. This is in part because the energy at the perimeter of the beam is less than the energy applied at a center of the beam and the energy at the perimeter of the beam may not be sufficient to fully dissociate the polarizing material.

A Process Space chart (FIG. 12B) is then used to determine the length of the beam that impinges on the polarizing sheet. The L3A Position from the Width Correlation chart is selected from along the abscissa. The width points are the laser beam profiler width points from the Width Correlation chart. To determine the length of the beam, from the L3A position, travel up the ordinate until finding an intersecting length point. An area of the beam can be determined by multiplying the width by the length. This is the beam area applied to the target polarizer region at an instance of time.

A Fluence chart (FIG. 12C) is then used to determine the energy density received within the beam incident region of the polarizer. Again, the L3A position is along the abscissa. At the appropriate L3A position, the intersecting point is determined. Along the ordinate is the energy and in mJ/mm². The velocity of the beam sweep is multiplied by the energy to derive the fluence.

A Power Delivered chart (FIG. 12D) can be used to identify the laser source power setting. The chart maps the laser power source to the power lost in transmission to the polarizer. The power delivered (W) to the polarized sheet is along the ordinate and the laser setpoint (W) at the laser light source (W) is along the abscissa. There is some available room within the derived results that will depolarize the layer without melting the substrate, such as ±5%, ±10%, ±15%, ±20% or ±25%.

### Example of Chart Usage

To depolarize a vertically set polarizer with a row width of 190 μm, the charts are used to determine the following.

From the Width Correlation chart, the L3A position is 10.5 mm, which correlates to a Laser Beam Profiler of 205 μm.

From the Process Space chart, the L3A position of 10.5 mm is used to find a beam area of 205 μm×435 μm or 89175 μm².

From the Fluence chart, the L3A of 10.5 mm corresponds to a fluence of 58 mj/mm² or 58 mj/10⁵ μm². This result in combination with the area from the Process Space Chart results in a power of 5.172 mj.

If the beam versus the polarizing layer velocity is set to 120 mm/sec, the beam is incident on any one spot for 435 μm/120,000 μm/sec or 0.0036 seconds.

At the above derived energy and time, the power is 5.172 mj/0.0036 sec or 1.436 watts. From the Power Delivery chart, 1.436 watts corresponds to about 4.2 watts required at the laser source.

Thus, depolarization requires 60 mj/mm², plus or minus some amount, such as 25%. More energy may melt the substrate and any other layers, such as the PVA/TAC as well as damage the LCD panel, and less will provide less than complete depolarization.

All of the above equations depend on known relationships, including

Power [watts]=energy/time=Joules/s

Irradiance [Watts/cm²]=power/area

Fluence [Joules/cm²]=(power×time)/area

### Example for Treating a Polarizing Film

A system like the system described in FIG. 11 was used to treat a polarizing film. The vertically set polarizer was treated to bleach 190 μm wide rows. A 532 nm green light laser (Spectra Physics Millenia® Pro 5s in CW mode) was used to generate 532 nm coherent light. The laser was set at a power of 4.2 watts. The light generated by the laser was directed through a beam focusing lens (CVI Laser, LLC, PLCX-15.0-51.5-C-532) to narrow down the beam. The optics were set to create a fluence of 58 mj/mm². The narrowed beam was then directed through two beam spreading lenses (CVI Laser, LLC, BICC-15.0-26.1-C-532) to broaden the beam. The broadened beam was then directed through a 1/2 wave rotatable wave plate set (Thor Labs, WPMH05M-532) to orient the light waves vertically, or in the same plane as the polarizer to be treated.

The orientated light waves were then remapped from a circular beam profile to a square beam profile using a remapper (Lambda Research Optics, Inc., LM-532-2230-S). The rectangular beam was then focused through a focusing lens (CVI Laser, LLC, PLCX-25.4-36.1-C-532) to again narrow down the beam. The edges of the beam were clipped by filtering the beam through a mechanical slit (Thor Labs, VS100). The beam was again narrowed through a beam focusing lens (CVI Laser, LLC, PLCX-25.4-39.2-C-532). The working distance of the final lens to the polarizing film was set by an adjustable beam focusing apparatus (CVI Laser, LLC PLCX-25.4-25.8-C-532, CVI Laser, LLC PLCX-25.4-20.6-C-532 or Newport Corporation KPX088AR.14), which set the lens 10.5 mm from the polarizing sheet and adjusted the beam width to 205 μm and length of 435 μm. The beam was aligned with a desired pixel on a twisted nematic LCD panel (AUO Optronics M201UN04 V0). The polarizing sheet (Nitto Denko, SEG1423DUHC) was then irradiated to form rows of non-polarizing regions having a width of 190 μm. The polarizing sheet was moved at a rate of 120 mm/sec to form the rows. At the time of irradiating, the polarizing sheet was on an LCD layer.

A number of embodiments of the invention have been described. Nevertheless, it will be understood that various modifications may be made without departing from the spirit and scope of the invention. For example, the surface of the polarizer could have a mask to help clearly leave open the area to bleach. Accordingly, other embodiments are within the scope of the following claims.

What is claimed is:

1. A method of forming a polarized pixel control layer assembly, comprising:
receiving an assembly comprising a pixel control layer mated with a first uniform polarization layer;
identifying a pixel cell within the pixel control layer; and
altering a first region of the first uniform polarizing layer that is associated with the pixel cell of the pixel control layer to deplete the region of light polarizing capabilities.

2. The method of claim 1, wherein the pixel control layer includes a liquid crystal display device.

3. The method of claim 1, wherein altering a first region comprises forming a non-polarizing row.

4. The method of claim 3, wherein:
identifying a pixel cell comprises identifying a row of pixels of the pixel control layer; and
altering a first region comprises altering a region corresponding to the row of pixels of the pixel control layer.

5. The method of claim 1, wherein altering a first region creates a first polarizing sheet with a polarizing region and a non-polarizing region, the method further comprising:
identifying a second region of a second uniform polarization layer of the assembly that is associated with the polarizing region of the first polarizing sheet; and
altering the second region of the second uniform polarizing layer to deplete the second region of light polarizing capabilities to form a second polarizing sheet with a polarizing region and a non-polarizing region.

6. The method of claim 5, wherein altering the second region forms a laminate with alternating polarizing regions, wherein the polarizing region of the first polarizing sheet alternates with the polarizing region of the second polarizing sheet.

7. The method of claim 6, further comprising:
identifying a third region of a third uniform polarization layer of the assembly, wherein the third uniform polarization layer is on an opposite side of the pixel control layer from the laminate and the third region is associated with the polarizing region of the second polarizing sheet; and
altering the third region of the second uniform polarizing layer to deplete the third region of light polarizing capabilities to form a third polarizing sheet with a polarizing region and a non-polarizing region.

8. The method of claim 5, further comprising mating the second uniform polarization layer to an opposite side of the pixel control layer from the first uniform polarization layer.

9. The method of claim 5, wherein altering a first region and altering a second region forms a checkerboard pattern of polarizing regions, wherein alternating polarizing regions polarize light at 90° with respect to one another.

10. The method of claim 5, wherein altering a first region and altering a second region forms an interleaved pattern of polarizing regions, and alternating polarizing regions are cross-polarizing with respect to one another.

11. The method of claim 1, wherein altering comprises directing radiation at the first region at a fluence sufficient to cause aligned polarizing material to become unaligned.

12. The method of claim 11, wherein altering comprises directing radiation at the first region at a fluence below that which ablates the first uniform polarization layer.

13. The method of claim 1, wherein identifying a pixel cell comprises locating the pixel cell through the polarizing layer.

14. The method of claim 1, further comprising altering a third region of the uniform polarizing layer.

15. A system, comprising:
light source;
a pixel control layer; and
a dual polarizer between the light source and the pixel control layer, wherein the system is configured such that the light emitted by the light source is directed as unpolarized light through the dual polarizer and the dual polarizer is a laminate with a contiguous surface.

16. The system of claim 15, wherein the dual polarizer is free of voids of any dimension greater than a wavelength of visible light.

17. The system of claim 15, wherein an upper surface and a lower surface of the dual polarizer at a first region that polarizes light of a first orientation are substantially coplanar with an upper surface and a lower surface of the dual polarizer at a second region that polarizes light at a second orientation that is orthogonal to the first orientation.

18. The system of claim 17, wherein:
the dual polarizer includes a first region and a second region, the first region is configured to polarize light of a first orientation and the second region is configured to polarize light at a second orientation that is orthogonal to the first orientation; and
the dual polarizer has a substantially constant index of refraction across the first region and the second region.

19. The system of claim 15, wherein:
the dual polarizer includes a first region and a second region, the first region is configured to polarize light of a first orientation and the second region is configured to polarize light at a second orientation that is orthogonal to the first orientation; and
the dual polarizer has a substantially constant photoelastic coefficient across the first region and the second region and over a variety of temperatures.

20. The system of claim 15, wherein the dual polarizer has a thickness of less than 500 microns.

21. The system of claim 15, wherein the dual polarizer includes an interleave polarizing pattern.

22. The system of claim 15, wherein the dual polarizer includes a checkerboard polarizing pattern.

23. The system of claim 15, wherein the dual polarizer has a layer with first regions that polarize light at a first orientation and third regions that do not polarize light.

24. The system of claim 23, wherein the first regions are characterized by a linearly oriented material on a substrate and the third regions are characterized by a randomly oriented material on the substrate.

25. The system of claim 15, wherein the pixel control layer is a liquid crystal display device having cells, wherein one or more cells form a pixel.

26. The system of claim 15, wherein the dual polarizer is a first dual polarizer and the system further comprises a second dual polarizer on an opposite side of the pixel control layer from the first dual polarizer.

27. The system of claim 26, wherein:
the first dual polarizer and the second dual polarizer each have a first region that polarizes light of a first orientation and a second region that polarizes light at a second orientation that is orthogonal to the first orientation; and
the first region of the first dual polarizer and the second region of the second dual polarizer are along a single axis perpendicular to a main surface of the first dual polarizer.
